(19) United States
(12) Patent Application Publication
(10) Pub. No.: US 2005/0271355 A1
(43) Pub. Date: Dec. 8, 2005

(54) Device, system and method of digitally recording audio/video

(76) Inventor: Avraham Gilor, New York, NY (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/971,055

(22) Filed: Oct. 25, 2004

Related U.S. Application Data
(60) Provisional application No. 60/576,312, filed on Jun. 3, 2004.

(51) Int. Cl. H04N 5/76; H04N 5/781

(52) U.S. Cl. 386/46; 386/125

(57) ABSTRACT

Briefly, some embodiments of the invention may provide devices, systems and methods of digitally recording audio/video. For example, a portable miniature audio/video recorder may include an an input port to receive video data; an encoder to compress said video data into corresponding compressed data; a storage unit to store said compressed data; a processor to write said compressed data into said storage unit; a power source to supply power to said encoder, said storage unit and said processor; and a communication port to transfer said compressed data from said recorder to an external device, wherein said input port, said encoder, said storage unit, said processor, said power source and said output port are adapted to be housed in a housing having a volume of not more than 90 cubic centimeters.

### PRIOR APPLICATION DATA

The present application claims priority and benefit from prior U.S. Provisional Application No. 60/576,312, entitled “Device, System and Method of Digitally Recording Audio/Video”, filed on Jun. 3, 2004 and incorporated herein by reference.

### FIELD OF THE INVENTION

The invention relates generally to the field of audio/video recorders, and more specifically, to a device, system and method for digital audio/video recording.

### BACKGROUND OF THE INVENTION

An audio/video (A/V) camera may capture audio and/or video, and may be connected to a storage device able to store data representing the captured audio and/or video. An A/V camera may be relatively small in size, e.g., some cameras may have a diameter as small as that of a 25-cents coin and may be relatively easily concealed. Conventional storage devices, for example, a Video Cassette Recorder (VCR), or a Digital Video Recorder (DVR), e.g., a TiVo DVR, may have a relatively large size, may have a relatively large weight, may require an Alternating Current (AC) power source, may not be portable, and may not be easily concealed.

### SUMMARY OF THE INVENTION

Some embodiments of the invention may include, for example, a device, system and method for receiving a signal representing A/V data, optionally converting the received A/V data from an analog format to a digital format, compressing the A/V data in accordance with a pre-defined scheme or algorithm, storing the compressed A/V data on an internal microdrive hard-disk drive or another relatively small digital storage device, and allowing the compressed A/V data to be read or accessed by a computer via a communication terminal.

A digital A/V recorder in accordance with an exemplary embodiment of the invention may include, for example, an internal rechargeable battery, an A/V input port able to receive signals carrying A/V data, an optional Analog to Digital (A/D) converter able to convert the received signals from an analog format to a digital format, an encoder able to compress the digital A/V data in accordance with a pre-defined scheme or algorithm, a processor able to store the compressed A/V data on an internal microdrive hard-disk drive or another relatively small digital storage unit, and a Universal Serial Bus (USB) port or other suitable wired or wireless communication terminal allowing the compressed A/V data to be read or accessed by a computer.

A digital A/V recorder in accordance with an exemplary embodiment of the invention may be lightweight, and may have a small size similar to the size of a 20-cigarettes pack. A digital A/V recorder in accordance with an exemplary embodiment of the invention may be a dedicated device, a portable device, a miniature device, and/or an easily concealable device.

In accordance with an exemplary embodiment of the invention, an easily concealable digital A/V recorder may be connected using a wired or wireless link to an easily concealable camera. In some embodiments, a miniature digital A/V recorder may include an integrated miniature camera. In some embodiments, a digital A/V recorder, or a digital A/V recorder and a camera, may be implemented as a stand-alone security device, spying device, monitoring device, listening device, filming device, alarm device, detection device, eavesdropping device, observation device, supervising device, undercover operations device, or the like. In some embodiments, a digital A/V recorder may be used, for example, by a home user for personal purposes, by a business user for business purposes, by security personnel for security purposes or secure operations, or the like.

A digital A/V recorder in accordance with an exemplary embodiment of the invention may be stand-alone device and may not include a camera, a lens, or a mechanism for acquiring A/V data. In some embodiments, for example, a portable miniature audio/video recorder may include an input port to receive video data; an encoder to compress said video data into corresponding compressed data; a storage unit to store said compressed data; a processor to write said compressed data into said storage unit; a power source to supply power to said encoder, said storage unit and said processor; and a communication port to transfer said compressed data from said recorder to an external device, wherein said input port, said encoder, said storage unit, said processor, said power source and said output port are adapted to be housed in a housing having a volume of not more than 90 cubic centimeters.

A digital A/V recorder in accordance with an exemplary embodiment of the invention may be self-powered, may include an internal rechargeable battery, and may operate without an external power source or an Alternating Current (AC) power source.

A digital A/V recorder in accordance with an exemplary embodiment of the invention may include a user interface, a one-button interface and/or a plurality of buttons, through which a user may operate the recorder, provide an instruction to record A/V data, provide an instruction to pause the recording, provide an instruction to stop the recording, provide an instruction to modify a property of the recording or of the operation of the recorder, delete some or all of the recorded A/V data, or perform other suitable operations.

A digital A/V recorder in accordance with an exemplary embodiment of the invention may optionally include, for example, a remote control connected to the recorder using a wired or wireless link. Using the remote control, a user may operate the recorder, provide an instruction to record A/V data, provide an instruction to pause the recording, provide an instruction to stop the recording, provide an instruction to modify a property of the recording or of the operation of the recorder, delete some or all of the recorded A/V data, or perform other suitable operations.

A digital A/V recorder in accordance with an exemplary embodiment of the invention may optionally include, for example, one or more vibration units located in the recorder and/or in a remote control connected to the recorder. The vibration units may, for example, vibrate in accordance with a pre-defined pattern in relation to an instruction received by the recorder or when a pre-defined condition is met.

A digital A/V recorder in accordance with an exemplary embodiment of the invention may optionally include, for example, one or more Light Emitting Diodes (LEDs) or other visible indications, able to indicate a property of the recorder or its operation. For example, the LEDs may provide an indication of the free storage capacity available for recording, an indication of the level of power available in the battery of the recorder, an indication of a property of the compression scheme used by the recorder, or the like.

A digital A/V recorder in accordance with an exemplary embodiment of the invention may optionally include, for example, an alarm port able to receive a triggering signal from an external device, e.g., an alarm system. The recorder may, for example, start recording A/V data, pause recording A/V data, or stop recording A/V data in relation to the received triggering signal

A digital A/V recorder in accordance with an exemplary embodiment of the invention may optionally include, for example, a delete button allowing a user to delete some or all of the A/V data stored in the recorder.

A digital A/V recorder in accordance with an exemplary embodiment of the invention may optionally include, for example, a locking mechanism allowing a temporary or permanent locking of the storage unit of the recorder.

A digital A/V recorder in accordance with an exemplary embodiment of the invention may optionally include, for example, a modifier button or interface allowing a user to modify one or more properties of the operation of the recorder.

A digital A/V recorder in accordance with an exemplary embodiment of the invention may optionally include, for example, a detector to detect whether the recorder is receiving video signals, whether the recorder is receiving audio signals, or whether the recorder is receiving both audio and video signals. The recorder may operate or modify its operation in relation to the detection results.

A digital A/V recorder in accordance with an exemplary embodiment of the invention may optionally include, for example, a charger able to charge a rechargeable battery included in the recorder.

A digital A/V recorder in accordance with an exemplary embodiment of the invention may optionally include, for example, a power-in port able to receive power from an external power source, e.g., an external battery or power supply unit.

A digital A/V recorder in accordance with an exemplary embodiment of the invention may optionally include, for example, a power-out port able to output power to an external device, e.g., a camera or an illumination device.

A digital A/V recorder in accordance with an exemplary embodiment of the invention may optionally include, for example, a Power Management Integrated Circuit (PMIC) able to control and/or monitor the operation of one or more of the battery, the charger, the power-in port and/or the power-out port.

A digital A/V recorder in accordance with an exemplary embodiment of the invention may optionally include, for example, an IEEE 1394 High Performance Serial Bus interface, an Apple FireWire interface, a Sony i.LINK interface, allowing connection of the recorder to a computer and allowing the compressed A/V data to be read or accessed by the computer.

A digital A/V recorder in accordance with an exemplary embodiment of the invention may optionally include, for example, a wireless communication port or terminal, e.g., in accordance with 802.11, 802.11a, 802.11b, 802.11g, 802.16, Wi-Fi, Wi-Max, BlueTooth, Infra-Red (IR), or other suitable standards or protocols, allowing connection of the recorder to a computer and allowing the compressed A/V data to be read or accessed by the computer.

A digital A/V recorder in accordance with an exemplary embodiment of the invention may optionally include, for example, an internal speaker able to produce audible indications in relation to a property of the recorder or to the operation of recorder.

A digital A/V recorder in accordance with an exemplary embodiment of the invention may optionally include, for example, a Real Time Clock (RTC) able to store data representing a time and/or date, or able to generate or store one or more parameters used in the operation of recorder.

A digital A/V recorder in accordance with an exemplary embodiment of the invention may optionally include, for example, a Phase-Locked Loop (PLL) able to provide timing and/or synchronization for one or more components of the recorder.

A digital A/V recorder in accordance with an exemplary embodiment of the invention may optionally include, for example, a decoder able to decompress or decode the compressed A/V data stored in the recorder. The decompressed video data may be provided, for example, to an internal display unit for display, and the decompressed audio data may be provided, for example, to an internal speaker for playback. Additionally or alternatively, the decompressed A/V data may be provided by the recorder using an A/V output port to an external device, for example, to a television or a monitor.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood from the following detailed description of exemplary embodiments of the invention and with reference to the accompanying drawings in which:

FIG. 1 is a schematic illustration of a block diagram of a digital A/V data recording system incorporating a camera, a computer, and a recorder in accordance with an exemplary embodiment of the invention;

FIG. 2 is a schematic illustration of a block diagram of a digital A/V data recorder in accordance with an exemplary embodiment of the invention;

FIG. 3 is a schematic flow-chart of a method of A/V data recording in accordance with an exemplary embodiment of the invention;

FIG. 4 is a schematic illustration of a block diagram of a digital A/V data recorder in accordance with another exemplary embodiment of the invention;

FIGS. 5A-5B are illustrations of a first side-view and a second side-view, respectively, of a digital data recorder in accordance with an exemplary embodiment of the invention;

FIG. 6 is an illustration of a digital data recorder in accordance with another exemplary embodiment of the invention; and

FIG. 7 is an illustration of a digital data recorder in accordance with another exemplary embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

It will be appreciated that the term “link” as used herein may include, for example, one or more cables, wires, connectors, conductors, or the like, and may include a wired and/or wireless link.

It will be appreciated that the term “port” as used herein may include, for example, any suitable connector, connection, interface, socket, terminal, plug, pin, ball, exit socket or port, entry socket or port, “in” socket or port, “out” socket or port, transmitter socket or port, receiver socket or port, or other connector or port able to receive or transmit data or signals as input and/or output

It will be appreciated that the term “A/V data” as used herein may include, for example, data representing video, data representing audio, or data representing audio and video.

It will be appreciated that the term “processor” as used herein may include, for example, a Central Processing Unit (CPU), a Digital Signal Processor (DSP), a microprocessor, a plurality of processors, a controller, a chip, a microchip, a circuit, a processing circuit, a sub-circuit, circuitry, or any other suitable multi-purpose or specific processor or controller or circuit.

It will be appreciated that the term “recorder” as used herein may include, for example a specific or multi-purpose unit or sub-unit or processor able to record data representing audio and/or video recording in accordance with embodiments of the invention.

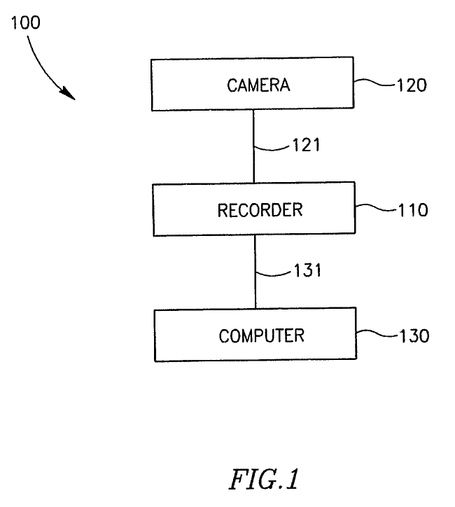

FIG. 1 schematically illustrates a block diagram of a recording system 100 incorporating a camera 120, a computer 130, and a digital A/V data recorder 110 in accordance with an exemplary embodiment of the invention.

Camera 120 may include, for example, an A/V camera able to capture audio and/or video. In some embodiments, camera 120 may be relatively small in size, for example, may be similar in shape, size or diameter to a 25-cents coin (e.g., a diameter of approximately 24 millimeters and a thickness or approximately 2, 3, 4 or 5 millimeters) or a button or a similar small object, and may be relatively easily concealed. Camera 120 may include, for example, one or more lens, a focusing mechanism, an illumination unit, a Charge Coupled Device (CCD) camera, a Complementary Metal Oxide Semiconductor (CMOS) camera, an optional microphone to capture audio, and/or other suitable cameras having various sizes and properties.

Computer 130 may include or may be, for example, a personal computer, a desktop computer, a mobile computer, a laptop computer, a notebook computer, a terminal, a workstation, a server computer, a Personal Digital Assistant (PDA) device, a tablet computer, a network device, or other suitable computing platform or computing device.

Recorder 110 may be connected to camera 120, for example, through a link 121. Recorder 110 may receive A/V data from camera 120, in an analog format or in a digital format. Optionally, if recorder 110 receives A/V data in an analog format, recorder 110 may convert the received A/V data from the analog format to a digital format. Recorder 110 may compress the digital A/V data in accordance with a pre-defined scheme or algorithm, and may store the compressed A/V data on a storage device, e.g., a microdrive hard-disk drive, a Compact Flash (CF) storage device, a Flash memory, or another relatively small storage device.

Recorder 120 may be connected to computer 130, for example, through a link 130. Computer 130 may access and retrieve the compressed A/V data stored in recorder 110.

It is noted that in some embodiments, link 121 and link 131 may not be simultaneously operational. For example, recorder 110 may first be connected to camera 120 through link 121 and may receive, compress and store A/V data. Then, recorder 110 may optionally be disconnected from camera 120 and may be connected to computer 130 through link 131, to allow computer 130 to access and retrieve the compressed A/V data stored in recorder 110.

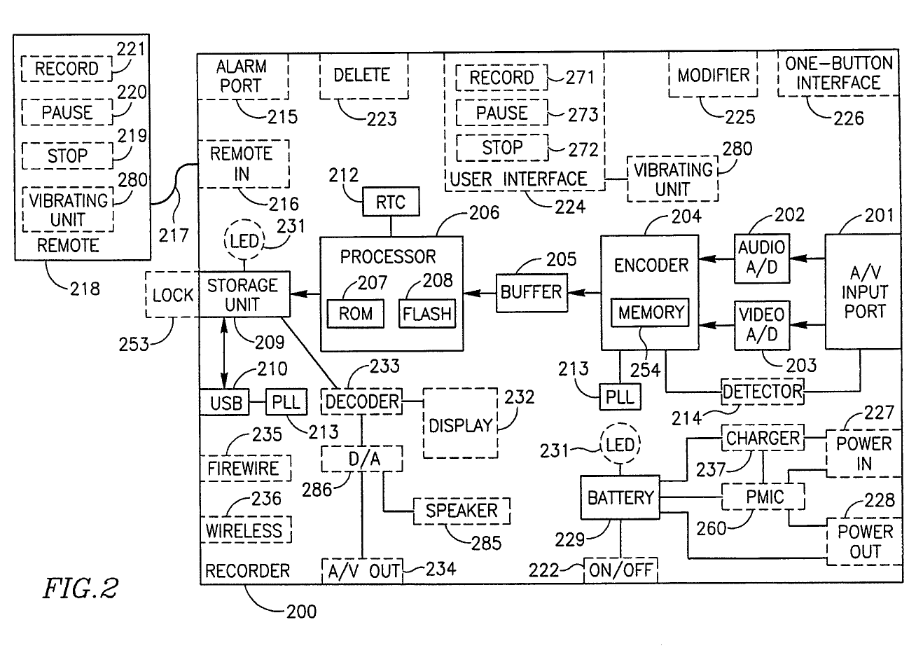

FIG. 2 schematically illustrates a block diagram of a digital data recorder 200 in accordance with some exemplary embodiments of the invention. Recorder 200 may be an example of recorder 110 of FIG. 1. Recorder 200 may be suitable for compression and recording of digital A/V data in accordance with some embodiments of the invention, and may include optional components which may provide recorder 200 with optional functionalities as detailed herein.

Recorder 200 may include, for example, an A/V input port 201, able to receive signals carrying A/V data. In some embodiments, A/V input port 201 may include, for example, a 3.5 millimeter minijack stereo A/V connector able to receive audio and video signals from a single A/V plug. A/V input port 201 may receive A/V data, for example, in an analog format from a camera, e.g., camera 120 of FIG. 1. Although a single A/V input port 201 is shown, able to receive signals carrying both audio and video data, a plurality of A/V input ports 201 may be used, e.g., a first input port to receive video signals and a second input port to receive audio signals, or a first input port to receive video signals and a second and third input ports to receive audio signals.

In one embodiment, the received A/V data may be in a digital format. In an alternate embodiment, the received A/V data may be in an analog format, and recorder 200 may convert the A/V data to a digital format. The received analog A/V data may be transferred from A/V input port 201 to one or more Analog to Digital (A/D) converters. For example, A/V input port 201 may transfer received audio data to an audio A/D converter 202, and may transfer received video data to a video A/D converter 203. Audio A/D converter 202 may include, for example, a processor able to convert audio data from an analog format to a digital format. In one embodiment, for example, audio A/D converter 202 may include a single ended, 24-bit audio A/D converter model AK5380 made by AKM. Video A/D converter 203 may include, for example, a processor able to convert video data from an analog format to a digital format. In one embodiment, for example, video A/D converter 203 may include a video input processor model SAA7113H made by Philips. Although two separate A/D converters 202 and 203 are shown, some embodiments may include a combined A/V A/D converter able to convert both audio and video data from an analog format to a digital format.

The digital A/V data, which was converted by A/D converters 202 and 203 or directly received from A/V input port 201, may be transferred to an encoder 204. Encoder 204 may include, for example, a processor able to encode or compress the digital A/V data, e.g., in accordance with a pre-determined encoding or compression algorithm or codec. The encoding or compression algorithm or codec may include, for example, Moving Picture Experts Group (MPEG), MPEG-1, MPEG-2, MPEG-3, MPEG-4, DivX, XviD, Video CD (VCD) format, Super VCD (SVCD) format, Joint Photographic Experts Group (JPEG), Motion-JPEG (MJPEG), Photo-JPEG, Windows Media Video, Windows Media Audio, one or more layers associated with MPEG encoding, RealVideo, RealAudio, H261, H263, Cinepak, Indeo, QuickTime, Digital Video Camera (DV-Cam), Four Character Code (FourCC), Lempel-Ziv-Welch (LZW), Huffman, Run Length Encoding (RLE), or other suitable lossy or substantially lossless algorithms or codecs.

Encoder 204 may optionally include a memory unit 254, e.g., able to store code, microcode, programmable microcode and/or data which may be used by encoder 204 during its operation. For example, memory unit 254 may include data or microcode indicating a bit-rate used during encoding operations, e.g., indicating a bit-rate of 128 kilobits per second.

In one embodiment, encoder 204 may include, for example, an MPEG-2 encoder model MB86393 made by Fujitsu, and may include a memory unit 254 of Synchronous Dynamic Random Access Memory (SD-RAM).

The compressed A/V data generated by encoder 204 may be transferred to a buffer 205, which may include, for example, a memory unit able to store data. Buffer 205 may include, for example, a First-In-First-Out (FIFO) buffer having a storage capacity of two kilobytes of data. Buffer 205 may optionally include a controller to control the operation of buffer 205, and/or an adaptation mechanism to allow buffer 205 to operate in association with various data transfer rates, e.g., using a bus width conversion mechanism. In one embodiment, for example, buffer 205 may include an eight kilobytes FIFO buffer able to operate at ×18 speed and including a bus width conversion mechanism, e.g., buffer model IDT72V263 made by IDT.

A processor 206 may be connected to buffer 205, and may be able to read data from buffer 205. For example, when the data stored in buffer 205 fills more than a pre-determined percentage, e.g., 50 percent, of the maximum storage capacity of buffer 205, then buffer 205 may send a signal to processor 206. Upon receiving the signal, processor 206 may read the compressed A/V data stored in buffer 205, and may write the compressed A/V data into a storage unit 209. In one embodiment, processor 206 may include, for example, a 30 MHz, 32-bit micro-controller having 512 kilobytes of Flash memory, e.g., micro-controller model M30833F made by Renesas Technology Corporation.

In some embodiments, buffer 205 may include a FIFO buffer, and the reading operation by processor 206 may free a storage space in buffer 205. Processor 206 may optionally include a Read Only Memory (ROM) 207, for example, able to store a Basic Input/Output System (BIOS) controlling the operation of processor 206. Processor 206 may optionally include a Flash memory 208, for example, a memory able to store code used in controlling the operation of processor 206 and/or data used during the operation of processor 206.

Storage unit 209 may include, for example, a hard-disk drive or a Flash memory able to store the encoded A/V data written by processor 206. In one embodiment, for example, storage unit 209 may include a hard-disk drive in a microdrive format, e.g., a four-gigabyte hard-disk drive in microdrive format, CompactFlash (CF) compatible, model HMS360404D5CF00, made by Hitachi/IBM.

In one embodiment, storage unit 209 may include a fixed and/or non-removable storage unit, e.g., a fixed hard-disk. In an alternate embodiment, storage unit 209 may include a removable storage unit, e.g., a removable hard-disk which may be detached and removed from recorder 200. In some embodiments, removable storage unit 209 may be removed from recorder 200 and may be inserted or connected to an external device, e.g., computer 130, a microdrive reader, a CF reader, a Flash memory reader, or the like, thereby allowing the external device to access, read, modify and/or delete the compressed A/V data stored in storage unit 209.

In another embodiment, storage unit 209 may include a removable storage unit locked by a lock 253, which may not allow unauthorized removal of storage unit 209 from recorder 200. For example, lock 253 may include a locking mechanism allowing removal of removable storage unit 209 using a key, or not allowing any removal of removable storage unit 209. This may allow, for example, using recorder 200 while avoiding

In some embodiments, processor 206 may write A/V data into storage unit 209 using discrete portions, e.g., using data blocks, packets and/or files. In one embodiment, data may be written as one or more MPEG or MPEG-2 files, and/or using a file extension of “MPG” or “MPEG” or “MP2”.

Storage unit 209 may be connected to a Universal Serial Bus (USB) port 210, which may include, for example, a port able to send and/or receive data in accordance with USB interface. USB port 210 may include, for example, a USB 1.0 port, a USB 1.1 port, a USB 2.0 port, a Plug-and-Play USB port, a mini-USB port, or other suitable ports. USB port 210 may include a USB device manager, for example, to control the operation of USB port 210. In one embodiment, for example, USB port 210 may include a USB 2.0 device manager model NET2270 made by NetChip. USB port 210 may connect storage unit 209 to, for example, computer 130 of FIG. 1, and may allow computer 130 to access and retrieve the compressed A/V data stored in storage unit 209.

In some embodiments, USB port 210 may optionally allow bi-directional communication between recorder 200 and an external device, e.g., computer 130 of FIG. 1. For example, in addition to allowing computer 130 to read A/V data stored in storage unit 209, USB port 210 may allow computer 130 to modify or delete A/V data stored in storage unit 209.

In some embodiments, recorder 200 may optionally include one or more other communication ports, instead of or in addition to USB port 210, to allow computer 130 to access and retrieve the compressed A/V data stored in storage unit 209. In one embodiment, for example, recorder 200 may optionally include an IEEE 1394 High Performance Serial Bus interface 235, e.g., an Apple FireWire interface or a Sony i.LINK interface.

In another embodiment, recorder 200 may optionally include a wireless interface 236 to allow computer 130 wireless access to the compressed A/V data stored in storage unit 209. Wireless interface 236 may include, for example, a transmitter, a receiver, a transmitter-receiver, a transceiver, an antenna, and/or other suitable units able to send and/or receive wireless signals. In some embodiments, wireless interface 236 may operate in accordance with one or more wireless communication standards or protocols, for example, 802.11, 802.11a, 802.11b, 802.11g, 802.16, Wi-Fi, Wi-Max, BlueTooth, Infra-Red (IR), or the like.

In some embodiments, recorder 200 may include a Phase-Locked Loop (PLL) 213 or a plurality of PLLs 213, for example, able to provide timing and/or synchronization for one or more components of recorder 200, e.g., encoder 204 or USB port 210. In one embodiment, for example, PLL 213 may include three programmable PLLs model CY22393 made by Cypress.

In some embodiments, recorder 200 may include a Real Time Clock (RTC) 212, for example, able to store data representing a time and/or date, or able to generate or store one or more parameters used in the operation of recorder 200. In one embodiment, for example, RTC 212 may include a low power RTC having an internal Random Access Memory (RAM), e.g., model MAX6900 made by Maxim. RTC 200 may, for example, generate data indicating a time, which may be used by processor 206 to produce a time-stamp associated with a compressed A/V data file written by processor 206 onto storage unit 209.

In some embodiments, recorder 200 may include a battery 229 able to provide power to one or more components of recorder 200. Battery 229 may include one or more power cells, removable batteries, non-removable batteries, replaceable batteries, non-replaceable batteries, rechargeable batteries and/or non-rechargeable batteries. In one embodiment, for example, battery 229 may include a rechargeable lithium-ion battery having a nominal voltage of 3.6V and a nominal capacity of 1950 mAh, e.g., model CGA103450A made by Panasonic. In one embodiment, battery 229 may provide power allowing recorder 200 to record A/V data for a period of about 3 hours. In some embodiments, recorder 200 may be self-powered, for example, battery 229 may provide sufficient power to recorder 200 and/or substantially all the components of recorder 200. In some embodiments, for example, recorder 200 may be self-powered and may not be connected to an external power source, e.g., to an Alternating Current (AC) source providing a voltage of approximately 110 or 220 volts. In some embodiments, for example, recorder 200 recorder 200 may be self-powered and may not include a power converter, e.g., to receive an external voltage or current and to convert, increase or decrease the received voltage or current to generate a current or voltage used by recorder 200.

In some embodiments, battery 229 may include a rechargeable battery connected to a battery charger 237, which may be connected to a power-in port 227 able to receive an input voltage. An external power source may provide power to charger 237 through power-in port 227, allowing charger 237 to charge or recharge the rechargeable battery 229, and/or to provide an operational power to one or more components of recorder 200. For example, in one embodiment, charger 237 may receive through power-in port 227 an input voltage of between 5V and 12V, and may charge or recharge battery 229 and/or provide an operational power to one or more components of recorder 200. In one embodiment, for example, charger 237 may include battery charger model MCP73843 made by MicroChip.

In some embodiments, battery 229 may optionally be connected to a power-out port 228 able to output a voltage, for example, to provide power to an external device, e.g., camera 120, a microphone, an illumination device, or the like. For example, battery 229 may output through power-out port 228 a Direct Current (DC) of 500 mA or a voltage of 5V.

In some embodiments, recorder 200 may optionally include a Power Management Integrated Circuit (PMIC) 260, for example, to control and/or monitor the operation of one or more of battery 229, charger 237, power-in port 227 and/or power-out port 228. For example, in one embodiment, PMIC 260 may include a triple-output PMIC model MAX1702B made by Maxim.

Recorder 200 may optionally include an on/off switch 222, able to turn recorder 200 on and off. Switch 222 may include, for example, a slide switch, and may be connected to battery 229 and/or to other components of recorder 222. Upon turning switch 222 on, recorder 200 may, for example, perform initialization operations, warming-up operations or other pre-recording preparatory operations, and may be operational and ready to record A/V data in response to one or more triggering events as detailed herein. Upon turning switch 222 off, recorder 200 may, for example, finalize outstanding operations and terminate the operation of one or more components of recorder 200.

Recorder 200 may record digital A/V data in response to one or more triggering events. In one embodiment, for example, recorder 200 may record digital A/V data in response to a triggering signal received from an external device through an alarm port 215. For example, recorder 200 may be connected through a link to an alarm system, which may send a triggering signal upon detection of a pre-defined movement or any movement. In some embodiments, recorder 200 may be turned on automatically and/or may record A/V data automatically upon receiving the triggering signal. In one embodiment, upon receiving a triggering signal, recorder 200 may record A/V data for a pre-defined period of time, e.g., thirty seconds.

Recorder 200 may record digital A/V data in response to an instruction provided by a user of recorder 200, for example, through a user interface 224 which may include one or more buttons or switches. For example, interface 224 may include a “record” button 271, which, when pressed by a user, may activate a recording session of recorder 200, e.g., by beginning to record digital A/V data into a new MPEG-2 file stored in storage unit 209. Interface 224 may further include a “stop” button 272, which, when pressed by a user, may terminate a recording session of recorder 200, e.g., by finalizing a creation of a MPEG-2 file stored in storage unit 209.

Interface 224 may further include a “pause” button 273, which, when pressed by a user during a recording session of recorder 200, may temporarily suspend the recording session without finalizing the creation of a MPEG-2 file stored in storage unit 209, and allowing a continuous recording of A/V data into a currently open MPEG-2 file upon a subsequent press by a user. In some embodiments, “pause” button 273 may temporarily suspend a recording session for a pre-defined period of time, e.g., ten minutes; when the pre-defined period of time elapses, in one embodiment, the recording session may automatically resume, or, in an alternate embodiment, the recording session may automatically terminate.

Recorder 200 may record digital A/V data in response to an instruction provided by a user of recorder 200, for example, through a remote control 218 connected to recorder 200 through a wired or wireless link 217 and a remote control input port 216. Remote control 218 may include one or more buttons or switches, for example, similar to “record” button 271, “stop” button 272, and/or “pause” button 273.

In some embodiments, a plurality of instructions may be provided using one button included in interface 224 or remote control 218. For example, in one embodiment, a multi-state switch may be used to switch between a “record” state, a “pause” state, and a “stop” state. In an alternate embodiment, a push-button may be used, for example, to allow various functionalities in relation to a property of the push performed on the button; for example, one long push may indicate a “record” instruction, two short pushes may indicate a “stop” instruction, one short push may indicate a “pause” instruction, or the like.

In some embodiments, in addition to or instead of user interface 224, recorder 200 may optionally include a one-button interface 226, which may include, for example, a push-button or a switch allowing a user to input a plurality of instructions. For example, a set of three short pushes of one-button interface 226 may indicate a “record” instruction, and a subsequent set of three short pushes of one-button interface 226 may indicate a “stop” instruction or a “pause” instruction.

In some embodiments, only one and not both of the user interface 224 and/or the one-button interface 226 and/or the remote control 218 may be operational at a certain time. For example, in one embodiment, recorder 200 may detect that a wired remote control 218 is connected to recorder 200 through link 217, may accept and perform instructions provided through remote control 218, and may ignore instructions provided by user interface 224 and/or one-button interface 226 while remote control 218 is connected to recorder 200.

In some embodiments, recorder 200 and/or remote control 218 may include one or more vibration units 280, e.g., one or more motors, able to vibrate or produce a one or more vibrations in accordance with a pre-defined pattern. The vibrations may be produced, for example, in relation to a received instruction or command, when a pre-defined condition is met, or in relation to an operational status or an operational property of recorder 200. For example, in one embodiment, recorder 200 and/or remote control 218 may vibrate upon receiving of an instruction or command by recorder 200, recorder 200 may vibrate for two seconds when recorder 200 stops recording A/V data, or recorder 200 may vibrate for one second when recorder 200 enters into a “pause” state. In an alternate embodiment, recorder 200 and/or remote control 218 may vibrate upon receiving an alarm signal through alarm port 215. In some embodiments, recorder 200 and/or remote 218 may be configured to temporarily avoid vibrating, e.g., upon an instruction from the user and for a pre-defined period of time, or until the vibration feature is turned on, or while a wired remote control 218 is connected to recorder 200.

In some embodiments, one or more components of recorder 200 may operate in accordance with a predetermined synchronization scheme, e.g., a predetermined timing or frequency scheme, for example, to allow smooth and/or real-time compression or recording of A/V data. For example, if the received A/V data includes data representing 30 frames per second, then recorder 200 may process and record the A/V data at 30 frames per second. For example, in some exemplary embodiments, video A/D converter 203 may convert 30 frames per second, encoder 204 may encode 30 frames per second, and processor 204 may write 30 frames per second into storage unit 209. In some embodiments, one or more optional timing components may be used to achieve such synchronization, for example, a clock, a timer, one or more buffers or delay units, PLL 213, or other suitable components.

In some embodiments, recorder 200 may optionally include one or more modifier buttons 225, for modifying one or more properties of the operation of recorder 200. In one embodiment, for example, modifier button 225 may modify the encoding bit-rate used by encoder 204, e.g., from 128 kilobit per second to 64 kilobit per second. In one embodiment, for example, modifier button 225 may modify the compression ratio or the quality of the encoded A/V data, e.g., to allow 2 hours, 4 hours, 6 hours or 8 hours of recording. In one embodiment, for example, modifier button 225 may modify a Frames Per Second (FPS) parameter used by encoder 204 and/or processor 206 and/or recorder 200, e.g., to allow recording of 30 FPS, 25 FPS, 15 FPS, or other suitable values. In some embodiments, for example, modifier button 225 may be used to instruct recorder 200 to record only video data, to record only audio data, or to record both audio and video data.

In some embodiments, recorder 200 may optionally include one or more Light Emitting Diodes (LEDs) 231 or any other visible indications, which may indicate a property of recorder 200 or its operation. For example, in some embodiments, LED 231 may be associated with on/off switch 222 and/or with battery 229, such that LED 231 may illuminate when recorder 200 is turned on or is recording or is ready to record, and such that LED 231 may not illuminate when recorder 200 is turned off. In an alternate embodiment, for example, illumination of LED 231 may indicate that recorder 200 is recording, or that recorder 200 is in “pause” mode and not recording. In another embodiment, a multi-color LED 231 may indicate a property of recorder 200, for example, a bit-rate used by encoder 204.

In some embodiments, for example, a multi-color LED 231 may indicate a ratio between an available storage capacity of storage unit 209 and a maximum storage capacity of storage unit 209; for example, in one embodiment, multi-color LED 231 may illuminate in green when the ratio is between 76 to 100 percent, may illuminate in white when the ratio is between 51 and 75, may illuminate in yellow when the ratio is between 26 and 50, and may illuminate in red when the ratio is 25 percent or less.

In some embodiments, for example, a multi-color LED 231 may indicate a ratio between an available power of battery 229 and a maximum power of battery 229; for example, in one embodiment, multi-color LED 231 may illuminate in green when the ratio is between 76 to 100 percent, may illuminate in white when the ratio is between 51 and 75, may illuminate in yellow when the ratio is between 26 and 50, and may illuminate in red when the ratio is 25 percent or less.

In some embodiments, recorder 200 may optionally include a delete button 223, to allow deletion of some or all of the A/V data stored in storage unit 209. In one embodiment, delete button 223 may include, for example, a push-button which may be relatively less easily operated, e.g., a one-millimeter delete button 223 sunk within recorder 200 and accessible using a pen or a pin or a needle, or a delete button 223 which may be operational only after being pressed for at least four seconds. In one embodiment, upon pressing delete button 223, substantially the entire A/V data stored in storage unit 209 may be deleted. In an alternate embodiment, upon pressing delete button 223, the least recent A/V data file stored in storage unit 209 may be deleted.

In some embodiments, recorder 200 may optionally include a detector 214, which may be operationally associated with encoder 204 and/or A/V input port 201. Detector 214 may include, for example, a controller able to detect whether A/V input port 201 is receiving video signals, whether A/V input port 201 is receiving audio signals, or whether A/V input port 201 is receiving both audio and video signals. Detector 214 and/or encoder 204 may perform operations or avoid performing operations in relation to the detection results. For example, in one embodiment, encoder 204 may avoid encoding A/V data if detector 214 detects that A/V input port 201 is not receiving A/V signals, or if detector 214 detects that A/V input port 201 is not receiving a video signal. In an alternate embodiment, for example, recorder 200 may generate a vibration using vibration unit 280, e.g., if detector 214 detects that A/V input port 201 is not receiving A/V signals, or if detector 214 detects that A/V input port 201 is not receiving a video signal. In some embodiments, for example, recorder 200 may operate in a “standby” mode, e.g., encoder 204 may encode A/V data, and/or processor 206 may store data into storage unit 209, only if detector 214 detects that A/V data is received by input port 201.

In some embodiments, recorder 200 may optionally include a display unit 232, which may include, for example, a Liquid Crystal Display (LCD), e.g., a color LCD, a monochrome LCD, a grayscale LCD, or the like. Display unit 232 may, for example, display one or more indications related to recorder 200 or its operation. For example, in some embodiments, display unit 232 may display an indication of a current mode of operation of recorder 200, e.g., a “record” mode, a “pause” mode, or a “stop” mode. In one embodiment, for example, display unit 232 may display an indication of a ratio between an available storage capacity of storage unit 209 and a maximum storage capacity of storage unit 209. In another embodiment, for example, display unit 232 may display an indication of a ratio between an available power of battery 229 and a maximum power of battery 229. In an alternate embodiment, for example, display unit 232 may display an indication of the encoding bit-rate used by encoder 204, of a compression ratio or a compression algorithm used by encoder 204, or the like.

In some embodiments, recorder 200 may optionally include a decoder 233, which may include, for example, a processor able to decode or decompress digital A/V data in accordance with a pre-defined protocol or algorithm. For example, decoder 233 may be connected to storage unit 209, may read a compressed MPEG-2 file stored in storage unit 209, and may decode the file to produce substantially uncompressed digital video data and/or audio data. In some embodiments, the uncompressed digital video data may optionally be converted from a digital format to an analog format, e.g., using a Digital to Analog (D/A) converter 286. In one embodiment, the uncompressed video data may be transferred to display unit 232, and the uncompressed audio data may be transferred to an optional speaker 285. In an alternate embodiment, the uncompressed A/V data may be transferred out of recorder 200, e.g., using an A/V output port 234, to an external display unit, playback unit, monitor, television, speaker, earphones, or other external devices.

In some embodiments, optionally, speaker 285 may produce audible indications in relation, for example, to a property of recorder 200 or to the operation of recorder 285. For example, speaker 285 may provide an audible indication when battery 229 has a pre-defined threshold value of available power, when storage unit 209 has a pre-defined threshold value of available storage capacity, when recorder 200 receives an instruction from a user through user interface 224 or remote control 218, or when pre-defined conditions or criteria are met. In one embodiment, speaker 285 may be turned off or turned on, for example, using user interface 224 or remote control 218, to allow a user to operate recorder 200 in a “silent mode” in which substantially no audible indications are generated.

In some embodiments, recorder 200 may have a relatively small size, or may be relatively lightweight. In some embodiments, for example, recorder 200 may have a weight or mass of approximately 80 grams or 2.8 ounces not including battery 229, a weight or mass of approximately 114 grams or 4 ounces including battery 229, a weight or mass of under 120 grams or 4.5 ounces or not more than 115 grams including battery 229, or a weight or mass of under 100 grams or 3 ounces not including battery 229. In some embodiments, recorder 200 may be easily concealable, e.g., under a shirt, under a pair of paints, inside an underwear garment, behind a wall-mounted painting, inside a drawer, under a bed, under a table, inside an internal or external pocket of a clothing article, or the like. For example, in some embodiments, recorder 200 may have a length of approximately 77 millimeters, a width of approximately 50.8 millimeters, and a depth of approximately 23 millimeters. In some embodiments, for example, recorder 200 may have a volume of approximately 90 cubic centimeters, a volume of approximately 3.05 fluid ounces, a volume smaller than 90 or 100 cubic centimeters, or a volume smaller than 3.0 or 3.3 fluid ounces.

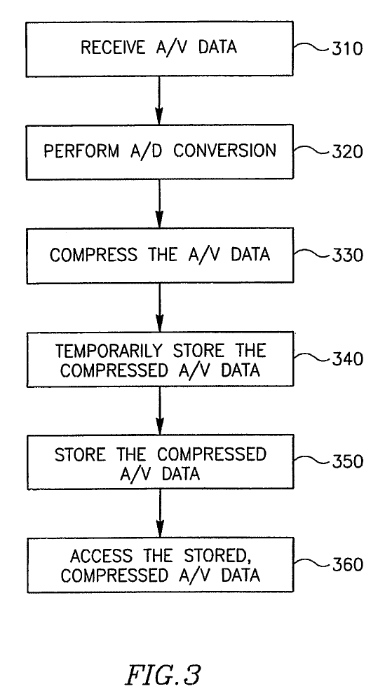

Reference is now made to FIG. 3, which is a schematic flow-chart of a method of A/V data recording in accordance with some embodiments of the invention. The method may be used, for example, by recorder 200, by recorder 110, or by other suitable devices or systems.

As indicated at block 310, the method may include receiving a signal carrying A/V data. This may be performed, for example, by A/V input port 201.

As indicated at block 320, the method may optionally include converting the received A/V data from an analog format to a digital format. This may be performed, for example, by A/D converters 202 and 203.

As indicated at block 330, the method may include compressing the A/V data in accordance with an encoding standard or a compression algorithm. This may be performed, for example, by encoder 204 and in accordance with MPEG-2 encoding.

As indicated at block 340, optionally, the method may include temporarily storing the compressed A/V data, for example, in FIFO buffer 205. This may be performed, for example, by encoder 204.

As indicated at block 350, the method may include storing the compressed A/V data storage unit, e.g., storage unit 209. This may be performed, for example, by processor 206, in discrete portions, and in accordance with a pre-determined file format or structure.

As indicated at block 360, the method may include accessing the stored, compressed A/V data. This may be performed, for example, by computer 130 which may be connected to recorder 200 through link 131 and USB port. The accessing may include, for example, reading A/V data stored in storage unit 209, modifying A/V data stored in storage unit 209, or deleting A/V data stored in storage unit 209. In an alternate embodiment, the accessing may be performed, for example, using a monitor or a television which may be connected to A/V output port 234 and may display the A/V data stored in storage unit 209.

Other suitable operations or sets of operations may be used in accordance with embodiments of the invention.

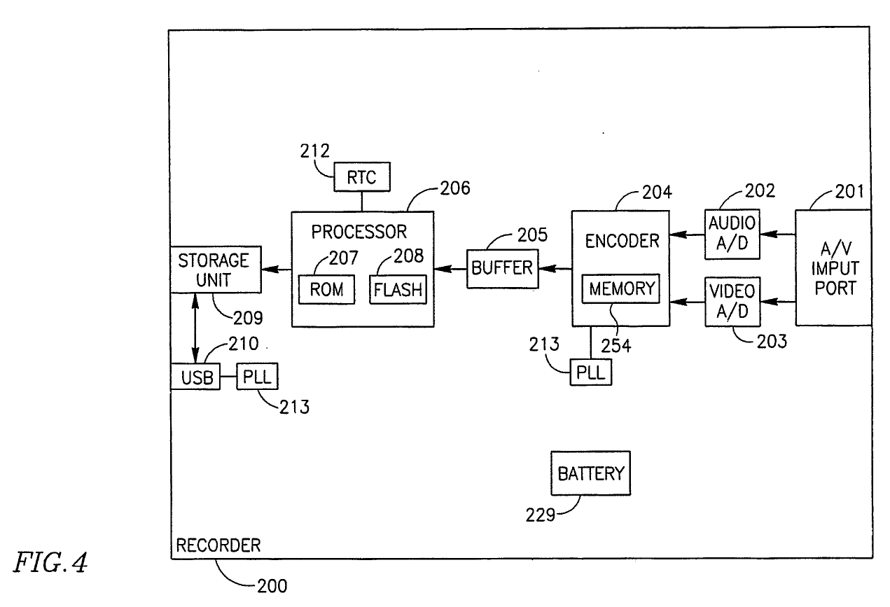

FIG. 4 schematically illustrates a block diagram of a digital data recorder 400 in accordance with another exemplary embodiment of the invention. Recorder 400 may be an example of recorder 110 of FIG. 1. Recorder 400 may be suitable for compression and recording of digital A/V data in accordance with some embodiments of the invention, and may not include some of the optional components shown in FIG. 2.

In some embodiments, recorder 400 may include, for example, A/V input port 201, audio A/D converter 202, video A/D converter 203, encoder 204 having memory unit 254, buffer 205, processor 206 having ROM 207 and Flash memory 208, storage unit 209, USB port 210, RTC 212, and one or more PLLs 213. Recorder 400 may optionally include one-button interface 226 or another suitable user interface.

The operation of recorder 400 and its components may be similar or substantially identical to the operation of recorder 200 and its corresponding components, as detailed with reference to FIG. 2.

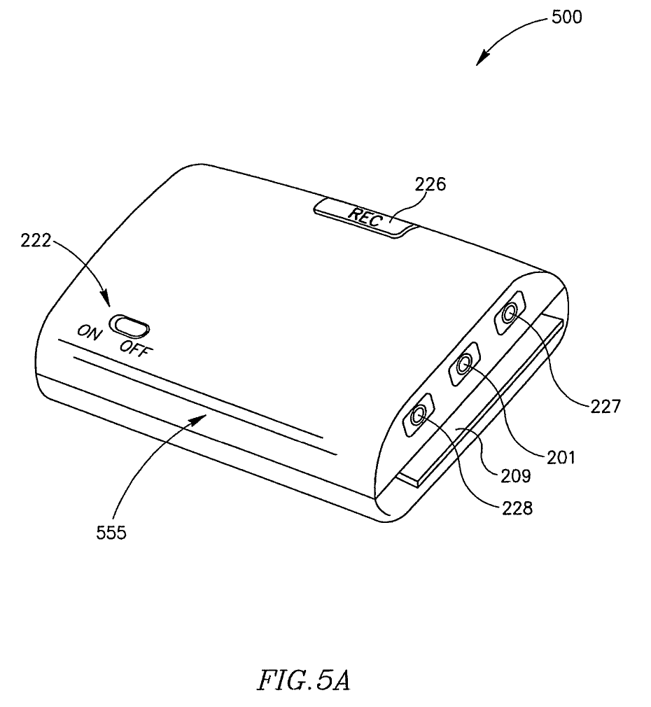

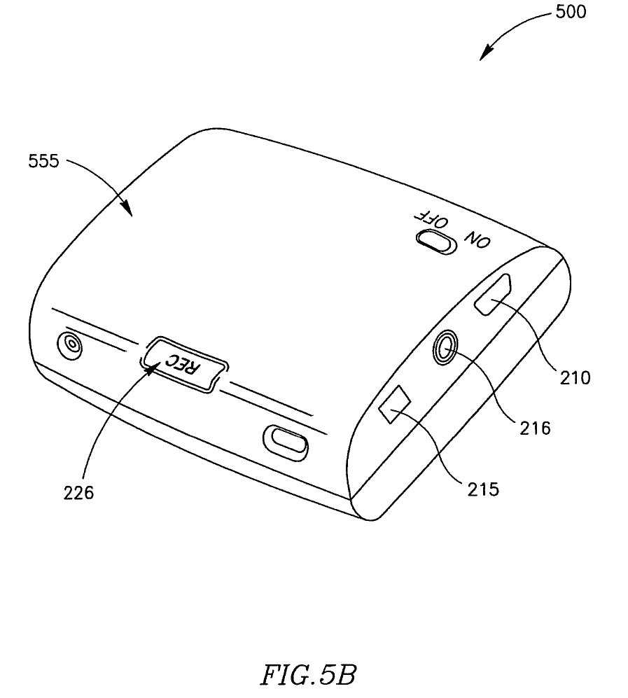

FIGS. 5A-5B illustrate a first side-view and a second side-view, respectively, of a digital data recorder 500 in accordance with an exemplary embodiment of the invention. Recorder 500 may be similar, for example, to recorder 110, recorder 200, or recorder 400. In some embodiments, some or all of the components of recorder 500 may be placed inside a housing 555, e.g., a stand-alone box or packaging made from plastic or other suitable materials.

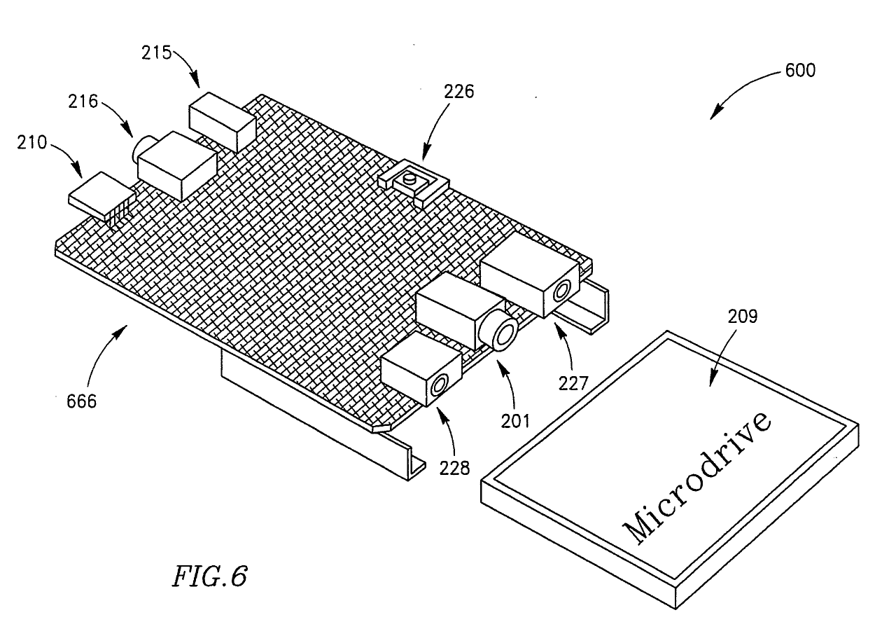

FIG. 6 illustrates a digital data recorder 600 in accordance with an exemplary embodiment of the invention. Recorder 600 may be similar, for example, to recorder 110, recorder 200, recorder 400 or recorder 500. Recorder 600 may be implemented, for example, using a processing circuit 666 which may include an Integrated Circuit (IC) or a processing board having one or more of the components of recorder 600.

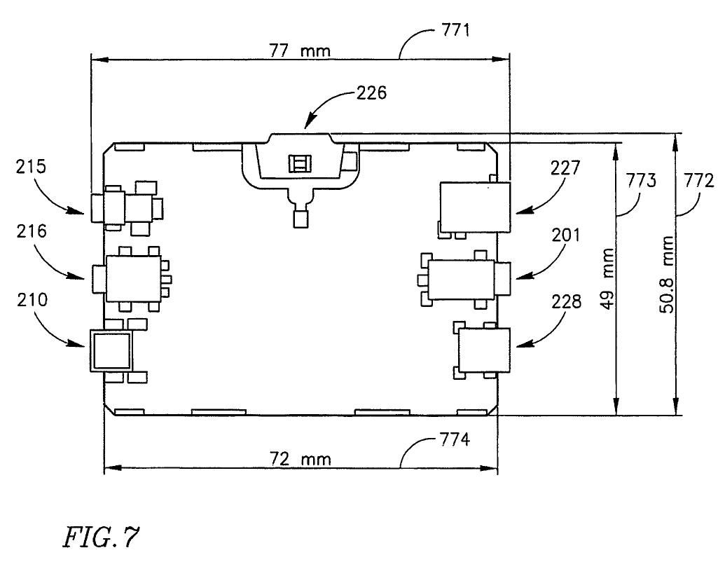

FIG. 7 schematically illustrates a digital data recorder 700 may be similar, for example, to recorder 110, recorder 200, recorder 400, recorder 500 or recorder 600. Arrows 771, 772, 773 and 774 indicate the sizes in millimeters of corresponding portions of recorder 700.

It will be appreciated that some embodiments of the invention may include, for example, a suitable combination of components of system 100 and/or recorder 200, which may be implemented using a single unit or inside a single housing. For example, a digital data recorder in accordance with one embodiment may include a housing or a package similar to housing 555 of FIG. 5A, including camera 120 of FIG. 1 and recorder 200 of FIG. 2. In an alternate embodiment, a digital data recorder may include, for example, a housing or a package similar to housing 555 of FIG. 5A, including camera 120 of FIG. 1 and recorder 400 of FIG. 4. Other suitable components or units may be combined, embedded or integrated within a common housing, package, board or circuit in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, storage units and/or memory units, for temporary or long-term storage of data or in order to facilitate the operation of a specific embodiment.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A portable miniature video recorder comprising:
an input port to receive video data;
an encoder to compress said video data into corresponding compressed data;
a storage unit to store said compressed data;
a processor to write said compressed data into said storage unit;
a power source to supply power to said encoder, said storage unit and said processor; and
a communication port to transfer said compressed data from said recorder to an external device,
wherein said input port, said encoder, said storage unit, said processor, said power source and said output port are adapted to be housed in a housing having a volume of not more than 90 cubic centimeters.

2. The recorder of claim 1, having a total mass of not more than 115 grams.

3. The recorder of claim 1, wherein said power source comprises a rechargeable battery.

4. The recorder of claim 1, wherein said encoder is able to compress said video data using a compression scheme selected from a group including a Moving Picture Experts Group (MPEG) compression scheme, an MPEG-2 compression scheme, an MPEG-4 compression scheme, a DivX compression scheme, and an XviD compression scheme.

5. The recorder of claim 1, wherein said storage unit comprises a hard disk drive.

6. The recorder of claim 1, wherein said storage unit comprises a Flash memory unit.

7. The recorder of claim 1, wherein said storage unit comprises a removable storage unit.

8. The recorder of claim 1, wherein said communication port comprises a port selected from a group including a Universal Serial Bus (USB) port, an IEEE 1394 port, a wireless communication port, and a wired communication port.

9. The recorder of claim 1, comprising an input detector to detect whether or not video data is received by said input port.

10. The recorder of claim 9, having a standby mode of operation, in which said processor writes data into said storage unit only if said input detector detects that video data is received by said input port.

11. The recorder of claim 1, comprising a power-in port able to receive power from an external power source.

12. The recorder of claim 1, comprising a power-out port able to supply power to a camera.

13. The recorder of claim 1, comprising a vibrating unit to produce a vibration in response to a signal indicating a change in an operational status of said recorder.

14. The recorder of claim 1, comprising a vibrating unit to produce a vibration in response to a signal indicating receipt of a command.

15. The recorder of claim 1, comprising a clock to provide time data, and wherein said processor is able to write into said storage unit a time stamp associated with said compressed data and based on said time data.

16. The recorder of claim 1, comprising a user interface to receive one or more user commands to be executed by said recorder.

17. The recorder of claim 1, wherein said one or more user commands are selected from a group including a command to start recording, a command to stop recording, a command to pause recording, a command to modify an operational status of said recorder, and a command to modify a value of a parameter used by said encoder.

18. The recorder of claim 17, wherein said user interface is a one-button user interface.

19. The recorder of claim 17, wherein said user interface comprises a remote control selected from a group including a wired remote control and a wireless remote control.

20. The recorder of claim 1, wherein said input port comprises an input port to receive video data and audio data,
wherein said encoder comprises an encoder to compress said video data into corresponding compressed video data and to compress said audio data into corresponding compressed audio data,
wherein said storage unit comprises a storage unit to store said compressed video data and said compressed audio data,
wherein said processor comprises a processor to write said compressed video data and said compressed audio data into said storage unit,
and wherein said communication port comprises a communication port to transfer said compressed video data and said compressed audio data from said recorder to an external device.

21. A system comprising:
a camera to acquire video and produce video data; and
a portable miniature video recorder comprising:
an input port to receive said video data from said camera;
an encoder to compress said video data into corresponding compressed data;
a storage unit to store said compressed data;
a processor to write said compressed data into said storage unit;
a power source to supply power to said encoder, said storage unit and said processor; and
a communication port to transfer said compressed data from said recorder to an external device,
wherein said input port, said encoder, said storage unit, said processor, said power source and said output port are adapted to be housed in a housing having a volume of not more than 90 cubic centimeters.

22. The system of claim 21, wherein said recorder has a total mass of not more than 115 grams.

23. The system of claim 21, wherein said encoder is able to compress said video data using a compression scheme selected from a group including a Moving Picture Experts Group (MPEG) compression scheme, an MPEG-2 compression scheme, an MPEG-4 compression scheme, a DivX compression scheme, and an XviD compression scheme.

24. The system of claim 21, wherein said camera comprises a camera to acquire video and audio and to produce video data and audio data,
wherein said input port comprises an input port to receive said video data and said audio data,
wherein said encoder comprises an encoder to compress said video data into corresponding compressed video data and to compress said audio data into corresponding compressed audio data,
wherein said storage unit comprises a storage unit to store said compressed video data and said compressed audio data,
wherein said processor comprises a processor to write said compressed video data and said compressed audio data into said storage unit,
and wherein said communication port comprises a communication port to transfer said compressed video data and said compressed audio data from said recorder to an external device.

26. The system of claim 21, wherein said camera has a diameter of under 24 millimeters and a thickness of under 5 millimeters.
